(19) United States
(12) Patent Application Publication
(10) Pub. No.: US 2010/0155645 A1
(43) Pub. Date: Jun. 24, 2010

(54) ANODIZING ELECTROLYTES FOR HIGH VOLTAGE CAPACITOR ANODES

(75) Inventors: Yanming Liu, Clarence Center, NY (US); Christina Scheuer, Amherst, NY (US)

Correspondence Address: Greatbatch Ltd., 10,000 Wehrle Drive, Clarence, NY, 14031, US

(73) Assignee: Greatbatch Ltd., Clarence, NY (US)

(21) Appl. No.: 11/559,968

(22) Filed: Nov. 15, 2006

Related U.S. Application Data
(63) Continuation-in-part of application No. 10/816,363, filed on Apr. 1, 2004, now abandoned.

(51) Int. Cl. H01G 9/022

(52) U.S. Cl. 252/62.2

(57) ABSTRACT

An anodizing electrolyte composition for valve metals including aluminum, niobium, titanium, tantalum, zirconium, and alloys thereof, is described. The electrolyte consists essentially of a protic solvent selected from the group consisting of alkylene glycols, polyalkylene glycols, and their mono ethers, and a weak inorganic or organic acid or its salt. A preferred electrolyte has polyethylene glycol mixed with phosphoric acid in de-ionized water. The electrolyte is capable of anodizing valve metals for high voltage capacitors to greater than 300 volts at temperatures below about 60° C. with little to no gray-out, high formation breakdown voltage and a high quality of dielectric oxide.

### CROSS-REFERENCE TO RELATED APPLICATION

This application is a continuation-in-part of application Ser. No. 10/816,363, filed Apr. 1, 2004, now abandoned.

### BACKGROUND OF THE INVENTION

1. Field of the Invention

The invention relates to a low temperature-anodizing electrolyte and to an electrochemical process for anodizing valve metals with that electrolyte.

2. Prior Art

Electrolytic capacitors contain anodes that are of a valve metal coated with its corresponding oxide (the dielectric) by an anodizing or formation process. The anodizing electrolyte and the process of forming an anode are critical for the electrical properties and performance of the capacitor, especially for a high voltage capacitor.

U.S. Pat. No. 5,716,511 to Melody et al. describes at column 1, lines 49 to 60 that during the anodizing process “the anodes are suspended in an electrolyte solution and anodized under appropriate current density to produce the anodic oxide dielectric. The anodizing step may be carried out at a temperature up to about 95° C. in an electrolyte which typically consists of a . . . mixed aqueous/ethylene glycol solution of a . . . salt of a mineral acid such as phosphoric . . . acid. Electrolytes which tend to give the best results (i.e. highest dielectric quality) often contain 50-60 vol. % [of]ethylene glycol or polyethylene glycol and 0.5 to 2 or more vol. % [of] phosphoric acid and are maintained at a temperature between 80° and 90° C.”

Melody et al. further teaches at column 3, lines 44 to 50 that of “[t]he organic solvents traditionally used to anodize tantalum anodes, ethylene glycol and polyethylene glycols . . . tend to have serious disadvantages. Ethylene glycol is toxic . . . and, the glycols and polyglycols tend to be viscous at lower temperatures.” However, they believed that lowering the temperature of the electrolyte composition below 50° C. during the anodization process is desirable because there is less chance of creating flaws on the anodized valve metal. Melody et al. teach that only using low viscosity organic solvents can accomplish anodizing at such low temperatures. Polyethylene glycol dimethyl ethers having from 4 to 10 repeating ethylene groups (generically referred to as “polyglycol di-ethers”) are preferred low viscosity solvents.

To confirm this, Melody et al. reported that polyethylene glycol dimethyl ethers of 4 to 10 repeating ethylene groups have a viscosity of 4.1 cps at 20° C. while ethylene glycol and polyethylene glycol 300 have viscosities of 20.9 and 75, respectively. Melody et al. assert that the viscosity values of glycols, polyglycols, and higher alkyl ethers of the polyethylene glycols, such as diethyl, dipropyl or dibutyl ethers are unacceptable for use with anodizing electrolytes below 50° C. In particular, they state that glycols and polyglycols become too viscous at such low temperatures, and polyethylene glycol higher dialkyl ethers do not provide the requisite solubility and low viscosity. (See column 3, line 44 to column 4, line 2, and column 4, lines 62 to 66.)

In order to illustrate the very high ultimate or sparking voltages which are possible with electrolytes based upon their preferred polyethylene glycol dimethyl ethers, even at 80°-90° C., Melody et al. prepared a series of electrolytes in Example 5 of their patent (column 7) containing 50 vol. % of one of the organic solvents list below in Table 1 mixed with de-ionized water and a sufficient quantity of 85% phosphoric acid to yield a resistivity of approximately 1,000 ohm-cm at 85° C. Anodes weighing approximately 0.9 gram, pressed from NRC (Starck) QR-12 tantalum powder and vacuum sintered so as to have 2,400 microcoulombs/gram C.V., were anodized to the breakdown point in each electrolyte at a current density of 50 milliamperes/gram. Breakdown or sparking voltage was indicated by a sudden reduction in voltage and violent gassing of the anodes. One anode was tested at a time in 250 ml of electrolyte in a magnetically stirred 250 ml stainless steel beaker.

TABLE 1

| Organic Solvent | Breakdown Voltage |
|---|---|
| Ethylene glycol | 240 Volts |
| Polyethylene glycol 300 | 260 Volts |
| Methoxypolyethylene glycol 350 | 285 Volts |
| Tetraethylene glycol dimethyl ether | 500 Volts |

Melody et al.'s conclusion was that organic solvents other than polyethylene glycol dimethyl ether are not acceptable for anodizing electrolytes. This is particularly the case when the electrolyte temperature is lower than about 50° C. (column 4, lines 62 to 63).

Breakdown voltage and quality of the dielectric oxide depend on the conductivity of the anodizing electrolyte, which, in turn, is a function of the solvent and solute concentrations. The electrolyte must have a breakdown voltage well above the intended anodizing voltage. Normally, increasing the electrolyte conductivity decreases the anodizing breakdown voltage. On the other hand, if the electrolyte conductivity is too low, excessive electrolyte heating at the anode may occur, resulting in “gray-out” on the anode, relatively low voltage breakdown and a poor quality dielectric oxide. Gray-out is an undesirable phenomenon observed during formation of tantalum bodies, especially those subjected to high voltage anodizing that result from the formation of crystalline tantalum oxide having relatively high DC leakage. It is also known that both electrolyte composition and formation protocol are crucial in preventing gray-out. Low electrolyte conductivity can also cause high voltage drop through the electrolyte and render the anodizing process impractical.

U.S. Pat. No. 6,288,889 to Komatsu et al. relates to an electrolyte made up of 20% to 80% by weight of an organic solvent such as ethylene glycol, 80% to 20% by weight of water, at least one carboxylic acids salt of carboxylic acid, inorganic acid, and salt of an inorganic acid, such as phosphoric acid, and a chelate compound. For example, electrolyte 6 in Table II (columns 9 and 10) comprises 55.0% ethylene glycol, 30% water, 14.2% ammonium sulfomate, 0.4% phosphoric acid and 0.4% EDTA (chelate), by wt. This electrolyte has a resistivity of 28 ohm-cm at 30° C. Even though Komatsu et al.'s electrolyte contains a significant amount of ethylene glycol, it is not acceptable for the present anodizing electrolyte; its resistivity is far too low for anodizing high voltage anodes. Instead, Komatsu et al. describe their electrolytes as being useful working electrolytes for low voltage capacitors.

Therefore, contrary to the teachings of Melody et al. and Komatsu et al., the present electrolyte consisting essentially of polyethylene glycol and phosphoric acid (H₃PO₄) in de-ionized water is useful for anodizing valve metal structures and particularly tantalum bodies, to relatively high formation voltages of about 300 volts and above. Furthermore, the anodizing process can be effectively carried out at relatively low temperatures of about 60° C. and below. Important criterion are that the electrolytes contain greater than about 50 vol. % organic solvents such as alkylene glycols, polyalkylene glycols, and their monoethers, and the ratio of the organic solvent to phosphoric acid is formulated so that the electrolyte has a resistivity greater than about 1,000 ohm-cm at 40° C.

### SUMMARY OF THE INVENTION

Accordingly, a preferred form of the present electrolyte consists essentially of alkylene glycols and/or polyalkylene glycols in a range of from about 50 vol. % to about 90 vol. %, and preferably from about 60 vol. % to about 80 vol. %, mixed with de-ionized water and from about 0.1 vol. % to about 15 vol. % of phosphoric acid. The glycol solvent and phosphoric acid can be mixed in many different combinations as long as their respective volume percentages stay within the above boundaries and the resulting electrolyte has a resistively from about 1,000 ohm-cm to about 30,000 ohm-cm, and preferably from about 5,000 ohm-cm to about 20,000 ohm-cm at 40° C. With the present electrolyte, valve metal bodies, and particularly pressed and sintered tantalum powder pellets, can be effectively anodized to 300 volts and more at relatively low temperatures of below about 60° C. The anodized valve metal body exhibits little to no gray-out, has high formation breakdown voltage, and a high quality dielectric oxide with low DC leakage and stable long term performance. These attributes have not been attainable with anodizing electrolytes know in conventional practice, such as those described by Melody et al. and Komatsu et al.

These and other aspects of the present invention will become increasingly more apparent to those skilled in the art by reference to the following detailed description and the appended drawing.

### BRIEF DESCRIPTION OF THE DRAWING

FIG. 1 is a graph constructed from the anode DC leakage (DCL in nA/CV) of pressed powder tantalum pellets anodized in various electrolyte formulations of polyethylene glycol (PEG400) and phosphoric acid mixed with de-ionized water.

### DETAILED DESCRIPTION OF THE PREFERRED EMBODIMENTS

The present invention is directed to electrolytes for anodizing valve metal bodies or structure of the type that are particularly useful in high voltage electrolytic capacitors. The electrolytes enable valve metals to be anodized at relatively low temperatures below about 60° C., but to relatively high formation voltages of about 300 volts, and more, with little to no gray-out and minimal voltage breakdown. The resulting high quality dielectric oxide has low DC leakage and provides stable long-term anode performance.

Suitable valve metals include, but are not limited to, tantalum, aluminum, niobium, titanium, zirconium, hafnium, and alloys thereof. When valve metals are used as an anode in an electrolytic capacitor, it is either in the form of a foil (etched or unetched) or a pressed and sintered powder pellet. For a tantalum electrolyte capacitor, the anode is typically in the form of a pressed and sintered tantalum powder pellet. Beam melt, sodium reduction, or other processes are commonly used to produce the tantalum powder. Regardless the process, pressed valve metal structures, and particularly pressed tantalum powder pellets, are anodized in a formation electrolyte after they have been sintered into a cohesive mass.

According to the present invention, the electrolyte consists essentially of a protic solvent, a relatively weak organic or inorganic acid or a salt thereof, and de-ionized water. The protic solvent preferably has a molecular weight of less than about 1,000 and, as the predominant component, is present at about 50 vol. % up to about 90 vol. %, preferably from about 60 vol. % to about 80 vol. %. The protic solvent is selected from the group consisting of alkylene glycols, polyalkylene glycols, alkylene glycol monoethers and polyalkylene glycol monoethers. Specifically preferred compounds include ethylene glycol, diethylene glycol, triethylene glycol, tetraethylene glycol, propylene glycol, trimethylene glycol, dipropylene glycol, glycerol, 2-methyl-1,3-propanediol, 1,4-butanediol, 2,3-butanediol, 2,2-dimethyl-1,3-propanediol, 2,4-pentanediol, 2,5-hexanediol, polyethylene glycols, polypropylene glycols, polyethylenepropylene glycol copolymers, ethylene glycol methyl ether, ethylene glycol ethyl ether, ethylene glycol butyl ether, diethylene glycol ethyl ether, diethylene glycol methyl ether, diethylene glycol butyl ether, dipropylene glycol methyl ether, tripropylene glycol methyl ether, and combinations thereof. Polyethylene glycol (PEG) in any one of its commercially available forms, such as PEG400, PEG600, and the like, is preferred.

The weak organic or inorganic acid or its salt thereof is present at from about 0.1 vol. % to about 15 vol. %. Exemplary compounds include phosphoric acid, ammonium dihydrogen phosphate, boric acid, ammonium borate, acetic acid, ammonium acetate, and mixtures thereof. 85% phosphoric acid is preferred.

De-ionized water is the remainder of the electrolyte.

Such electrolytes have resistivities at 40° C. of from about 1,000 ohm-cm (conductivity of 1.0 mS/cm) to about 30,000 ohm-cm (conductivity of 0.033 mS/cm), and preferably from about 5,000 ohm-cm (conductivity of 0.2 mS/cm) to about 20,000 ohm-cm (conductivity of 0.05 mS/cm).

During anodizing, the electrolyte is preferably maintained at a temperature about 60° C. and below. Conventional practice has been to form the valve metal to a target formation voltage at a constant current or varied current, with or without rest steps. The formation protocol and the current depend on the electrolyte, the valve metal powder type and the size of the valve metal structure. Adjusting these parameters according to conventional practice is well within the knowledge of those skilled in the art. Nonetheless, a preferred formation protocol using the present anodizing electrolytes is disclosed in U.S. Pat. No. 6,231,993 to Stephenson et al. Other suitable formation protocols are disclosed in U.S. Application Pub. Nos. 2006/0191796 to Muffoletto et al. and 2006/0196774 to Liu et al. This patent and these publications are assigned to the assignee of the present invention and incorporated herein by reference. After the formation process, the anode is exposed to conventional heat treatment and reformation procedures. Both of these procedures are well known to those of ordinary skill in the capacitor art.

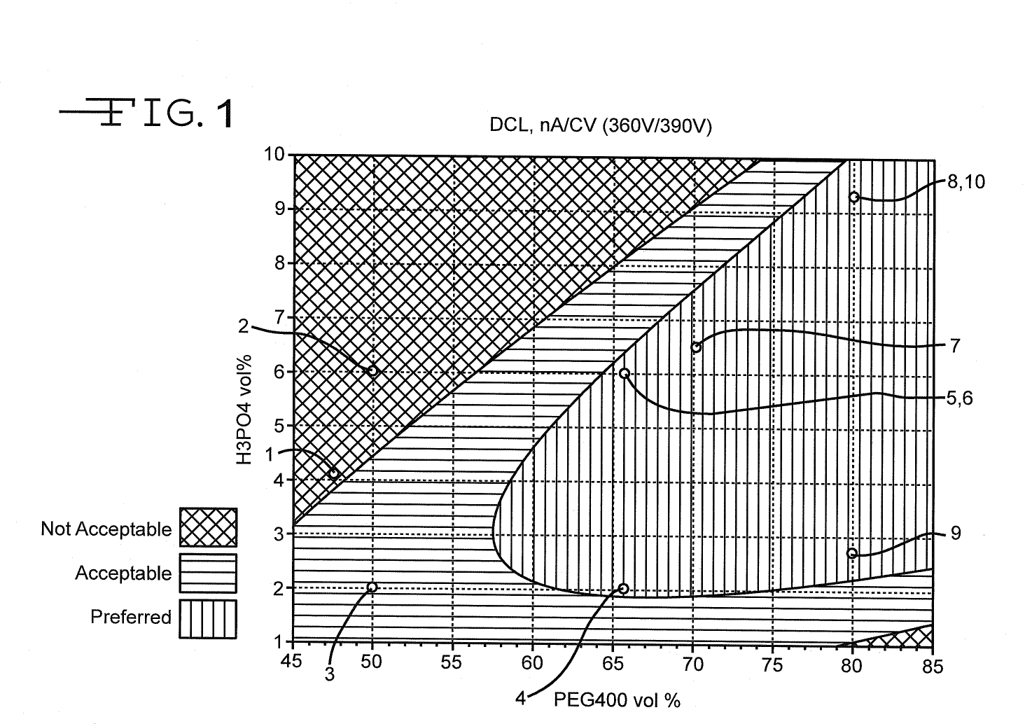

Specific examples of different electrolytes are listed in Table 2 and FIG. 1.

TABLE 2

| | | | | | | | Anode |
|---|---|---|---|---|---|---|---|
| | | | Electrolyte | Electrolyte | Anode | Anode | AC |
| Electrolyte | | | Conductivity | Resistivity | DC Leakage | DC Leakage | Capacitance |
| No. | PEG400* | H3PO4* | mS/cm | Ohm-cm | DCL | nA/CV | microfarad |
| 1 | 47.6 | 4.1 | 2.55 | 392 | 100.0 | 2.07 | 124.0 |
| | 50.0 | 10.0 | 6.05 | 165 | Breakdown at | | |
| | | | | | 330 V during | | |
| | | | | | formation | | |
| 2 | 50.0 | 6.0 | 2.99 | 334 | 146.4 | 3.02 | 124.4 |
| 3 | 50.0 | 2.0 | 1.15 | 870 | 70.3 | 1.43 | 125.8 |
| 4 | 65.7 | 2.0 | 0.24 | 4219 | 45.3 | 0.92 | 126.2 |
| | 65.7 | 10.0 | 1.52 | 657 | Breakdown at | | |
| | | | | | 375 V during | | |
| | | | | | formation | | |
| 5 | 65.7 | 6.0 | 0.77 | 1295 | 44.4 | 0.91 | 125.0 |
| 6 | 65.7 | 6.0 | 0.77 | 1295 | 31.3 | 0.64 | 125.7 |
| 7 | 70.1 | 6.5 | 0.26 | 3846 | 29.4 | 0.61 | 123.6 |
| 8 | 80.0 | 9.3 | 0.21 | 4831 | 23.3 | 0.48 | 124.3 |
| 9 | 80.0 | 2.7 | 0.05 | 21739 | 31.8 | 0.63 | 128.6 |
| 10 | 80.0 | 9.3 | 0.28 | 3623 | 19.0 | 0.39 | 124.4 |

*Volume percent

Electrolytes 1 to 10 in Table 2 are indicated in the graph of FIG. 1. The contour graph shows the variation in DC leakage as a function of the electrolyte composition for anodes weighing approximately 7 gram, pressed from HC Starck QR3 tantalum powder, vacuum sintered at 1,600° C. for 15 minutes, anodized in the respective electrolytes, and tested at 360 volts.

Electrolytes 4 to 10 have resistivities above about 1,000 ohm-cm and are, consequently, preferred formulations. Electrolyte 3 has a resistivity of 870 ohm-cm and may be acceptable for certain applications but, in general, would not be used. Electrolytes 1 and 2 are not acceptable as their resistivities are too low and the resulting DC leakage is too high.

In that respect, FIG. 1 illustrates that a suitable ratio of solvent and solute is needed to obtain low DC leakage (nA/CV) and prevent breakdown during formation to 300 volts, and higher, of a pressed valve metal pellet such as a tantalum pellet. The resulting dielectric oxide exhibits little to no gray-out with reduced breakdown voltage failure and low DC leakage. These attributes result in stable long-term performance of the anodized tantalum pellet as an anode in an electrolytic capacitor. A low conductivity results from a higher ratio of solvent and solute.

It is appreciated that various modifications to the present inventive concepts described herein may be apparent to those of ordinary skill in the art without departing from the spirit and scope of the present invention as defined by the herein appended claims.

1. An electrolyte for anodizing a valve metal body, the electrolyte consisting essentially of:
a) a protic solvent selected from the group consisting of alkylene glycols, polyalkylene glycols, alkylene or polyalkylene glycol mono ethers, and combinations thereof;
b) a weak inorganic or organic acid, or its salt selected from the group consisting of ammonium dihydrogen phosphate, boric acid, ammonium borate, acetic acid, ammonium acetate, and combinations thereof; and
c) wherein the protic solvent and the weak inorganic or organic acid, or its salt, are at a predetermined ratio of volume percentages to provide the electrolyte having a resistivity of at least about 1,000 ohm-cm at 40° C.

2. The electrolyte of claim 1 wherein the protic solvent is selected from the group consisting of ethylene glycol, diethylene glycol, triethylene glycol, tetraethylene glycol, propylene glycol, trimethylene glycol, diepropylene glycol, glycerol, 2-methyl-1,3-propanediol, 1,4-butanediol, 2,3-butanediol, 2,2-dimethyl-1,3-propanediol, 2,4-pentanediol, 2,5-hexanediol, polyethylene glycols, polypropylene glycols, polyethylenepropylene glycol copolymers, ethylene glycol methyl ether, ethylene glycol ethyl ether, ethylene glycol butyl ether, diethylene glycol ethyl ether, diethylene glycol methyl ether, diethylene glycol butyl ether, dipropylene glycol methyl ether, tripropylene glycol methyl ether, and combinations thereof.

3. (canceled)

4. The electrolyte of claim 1 wherein the protic solvent ranges from about 50 vol. % to about 90 vol. % of the electrolyte.

5. The electrolyte of claim 1 wherein the protic solvent has a molecular weight of less than about 1,000.

6. The electrolyte of claim 1 wherein the weak inorganic or organic acid, or its salt thereof, is in a range of from about 0.1 vol. % to about 15 vol. %.

7. The electrolyte of claim 1 having a resistivity at 40° C. of from about 1,000 ohm-cm to about 30,000 ohm-cm.

8. The electrolyte of claim 1 having a resistivity at 40° C. of from about 5,000 ohm-cm to about 20,000 ohm-cm.

9. An electrolyte for anodizing a valve metal body, the electrolyte consisting essentially of:
a) a polyethylene glycol;
b) an acid or its salt selected from the group consisting of ammonium dihydrogen phosphate, boric acid, ammonium borate, acetic acid, ammonium acetate, and combinations thereof;
c) water; and
d) wherein the polyethylene glycol and the phosphoric acid are at a predetermined ratio of volume percentages to provide the electrolyte having a resistivity of at least about 1,000 ohm-cm at 40° C.

10. The electrolyte of claim 9 wherein the polyethylene glycol ranges from about 50 vol. % to about 90 vol. % of the electrolyte.

11. The electrolyte of claim 9 wherein the phosphoric acid is in a range of from about 0.1 vol. % to about 15 vol. %.

12. The electrolyte of claim 9 having a resistivity at 40° C. of from about 1,000 ohm-cm to about 30,000 ohm-cm.

13. A method for providing an electrolyte that is useful for anodizing a valve metal, comprising the steps of:
a) providing a protic solvent selected from the group consisting of alkylene glycols, polyalkylene glycols, alkylene or polyalkylene glycol mono ethers and combinations thereof; and
b) selecting a weak inorganic or organic acid or its salt from the group consisting of ammonium dihydrogen phosphate, boric acid, ammonium borate, acetic acid, ammonium acetate, and combinations thereof; and
c) mixing the protic solvent and the weak inorganic or organic acid, or its salt, are at a predetermined ratio of volume percentages thereby providing the electrolyte having a resistivity of at least about 1,000 ohm-cm.

14. The method of claim 13 including selecting the protic solvent from the group consisting of ethylene glycol, diethylene glycol, triethylene glycol, tetraethylene glycol, propylene glycol, trimethylene glycol, diepropylene glycol, glycerol, 2-methyl-1,3-propanediol, 1,4-butanediol, 2,3-butanediol, 2,2-dimethyl-1,3-propanediol, 2,4-pentanediol, 2,5-hexanediol, polyethylene glycols, polypropylene glycols, polyethylenepropylene glycol copolymers, ethylene glycol methyl ether, ethylene glycol ethyl ether, ethylene glycol butyl ether, diethylene glycol ethyl ether, diethylene glycol methyl ether, diethylene glycol butyl ether, dipropylene glycol methyl ether, tripropylene glycol methyl ether, and combinations thereof.

15. (canceled)

16. The method of claim 13 including providing the protic solvent ranging from about 50 vol. % to about 90 vol. % of the electrolyte.

17. The method of claim 13 including providing the protic solvent having a molecular weight of less than about 1,000.

18. The method of claim 13 including providing the weak inorganic or organic acid, or its salt thereof, ranging from about 0.1 vol. % to about 15 vol. %.

19. The method of claim 13 including providing the electrolyte having a resistivity at 40° C. of from about 1,000 ohm-cm to about 30,000 ohm-cm.

20. The method of claim 13 including using the electrolyte to anodize the valve metal to a formation voltage of at least about 300 volts.

21. The method of claim 13 including using the electrolyte to anodize the valve metal at a temperature of about 60° C. or lower.
